(19) United States
(12) Patent Application Publication
(10) Pub. No.: US 2010/0329688 A1
(43) Pub. Date: Dec. 30, 2010

(54) UNIVERSAL REMOTE-CONTROL SIGNAL TRANSMITTING DEVICE FOR CONTROLLING IR EQUIPMENT AND A SETTING METHOD THEREOF

(76) Inventor: Darniel YOUNG, Tsuen Wan (HK)

Correspondence Address: OSTROLENK FABER GERB & SOFFEN, 1180 AVENUE OF THE AMERICAS, NEW YORK, NY, 100368403, US

(21) Appl. No.: 12/617,206

(22) Filed: Nov. 12, 2009

(30) Foreign Application Priority Data
Jun. 25, 2009 (CN) 200910031790.9

(51) Int. Cl. H04B 10/00

(52) U.S. Cl. 398/106

(57) ABSTRACT

A universal remote-control signal transmitting device for controlling IR equipment and a setting method thereof. The universal remote-control device uses code identification to perform simple setting. The device includes an IR transmitting circuit and a key control device. The universal remote-control signal transmitting device is also fitted with a single chip processor, an IR receiving circuit and a memory for storing an IR signal code database and programs for analyzing and processing. The setting method includes the steps: 1) receiving codes; 2) calculating; 3) comparing; 4) setting; 5) completing. Compared with existing universal remote-control devices, this device adds an IR receiving circuit and a memory for storing programs for analyzing and processing, and by receiving IR signals of the IR remote-control devices of the existing equipment and solving the IR signals, and comparing the solved results with data in the database, there is a rapid match with existing equipment, so as to command the existing equipment.

### TECHNICAL FIELD

The present invention relates to a universal remote-control device and, particularly, to a universal remote-control device which uses code identification to perform simple setting, and a setting method thereof.

### BACKGROUND ART

Infrared (IR) remote control has a long history in the field of household entertainment equipment control. Various types of IR codes are used by various companies in their respective equipment. A universal remote-control device can control different pieces of equipment by way of its setting.

However, setting universal remote-control devices is not easy. A user has to test the device according to different setting numbers in the user's manual. The user has to test setting numbers one by one and repeatedly to determine whether the device works or not. This will take a very long time by making repeated selections. Even if preset code names are utilized by way of brand name searching, the user is still required to make confirmation one by one. It will take the user a very long time to set it.

### SUMMARY OF THE INVENTION

The present invention proposes a universal remote-control signal transmitting device for controlling IR equipment, which can be set rapidly, simply and accurately, and proposes its setting method.

The universal remote-control signal transmitting device of the present invention comprises an IR transmitting circuit capable of sending IR signals for controlling various pieces of equipment to be controlled and a key control device. By operating the key control device, the universal remote-control signal transmitting device can be paired with the one piece of controlled equipment. After the pairing, the universal remote-control signal transmitting device can replace the original IR remote-control device of the one piece of controlled equipment. The universal remote-control signal transmitting device is also fitted with a single chip processor, an IR receiving circuit and a memory for storing an IR signal database and programs for analyzing and processing.

The IR receiving circuit receives signals transmitted by the original IR remote-control device when a certain key action takes place, and analyzes and processes the signals by the single chip processor and the memory, then obtains one setting number corresponding to the signals in the database of the memory, wherein, the setting number makes a one-to-one correspondence between the key in the key control device and the key in the original IR remote-control device. In accordance with actions of each key in said key control device, the IR transmitting circuit transmits IR command signals which can instruct the one piece of controlled equipment to execute some operations accordingly.

The setting method for the universal remote-control signal transmitting device of the present invention is executed by the following steps:

1) receiving codes: making the original IR remote-control device correspond to the signal receiving port of the IR receiving circuit of the universal remote-control device, and pressing a prescribed key for the IR receiving circuit to acquire IR signals corresponding to the prescribed key;

2) calculating: having the acquired IR signals corresponding to the prescribed key analyzed and solved, to search and calculate such information of the IR signals as the digit number, head code time, 0/1 code time, times of frame, frequency of IR carrier wave, etc., and organize codes for the information;

3) comparing: comparing the above information codes with data in the database to find the matched data in the database, that is, to locate the data and obtain a setting number;

4) setting: storing the setting number, and forming in accordance with the setting number a selected setting function with one-to-one correspondence between the keys of the key operation circuit of the universal remote-control signal transmitting device and the keys of the original IR remote-control device; and

5) completing.

When organizing codes for the information of the IR signals in step 2), an MCU organizes the information of the IR signals as information codes which can be recognized by the database.

Compared with the existing universal remote-control device, the present invention adds an IR receiving circuit and a memory for storing programs for analyzing and processing. By receiving IR signals of the IR remote-control devices of the existing equipment and solving the IR signals, and comparing the solved results with data in the database, the universal remote-control device of the present invention rapidly matches with the existing equipment, so as to command the existing equipment. The setting method of the present invention is mainly realized by way of “learning”. First, a specified IR code is received, and the IR code is analyzed and reorganized. Then it is compared with the IR code in the database. If a match is found, then a setting number is generated and determined. In accordance with the setting number, it can form a selection and setting function with one-to-one correspondence between the keys in the key operation circuit of the universal remote-control device and the keys of the original IR remote-control device. The existing pieces of equipment of some brands have identical specific IR codes, while some other codes are not the same. In case a user finds that some keys of the default setting number cannot be used, reference can be made to the first method for learning keys and the multi-key matching operation can be set by using the original IR remote-control device and pressing down the specified second key, the third key. Using different keys to carry out the setting can make the setting more accurate. The more keys are learned, the more accurate it can become.

### BRIEF DESCRIPTION OF THE DRAWINGS

FIG. 1 is a principle block diagram of the present invention

FIG. 2 is a circuit diagram of the IR receiving circuit in the present invention

FIG. 3 is a work flowchart of the present invention

### DESCRIPTION OF PREFERRED EMBODIMENTS

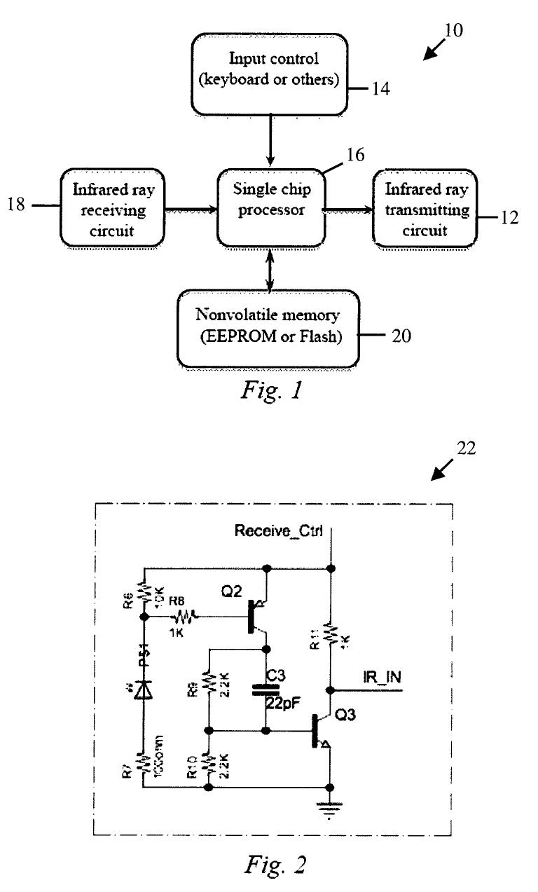

The universal remote-control signal transmitting device 10 for controlling IR equipment of the present invention, as shown in FIGS. 1 and 2, comprises an IR transmitting circuit 12 capable of transmitting IR signals for controlling various pieces of controlled equipment and a key control device 14, which is a key operation circuit or other devices for controlling signals capable of stimulating key operations. By operating the key control device 14, the universal remote-control signal transmitting device can be paired with the one piece of controlled equipment. After the pairing, the universal remote-control signal transmitting device 10 can replace the original IR remote-control device of the one piece of controlled equipment. The universal remote-control signal transmitting device is also fitted with a single chip processor 16, an IR receiving circuit 18 and a memory 20 for storing an IR signal code database and programs for analyzing and processing.

The IR receiving circuit 22 receives signals transmitted by the original IR remote-control device when a certain key action takes place, and analyzes and processes the signals through the single chip processor 16 and memory, then obtains one setting number corresponding to the signals in the database of the memory, wherein, the setting number makes a one-to-one correspondence between the key in the key control device and the key in the original IR remote-control device. The IR transmitting circuit transmits, in accordance with actions of each key in said key control device, IR command signals which can instruct the one piece of controlled equipment to execute some operations accordingly.

Another embodiment of the universal remote-control signal transmitting device of the present invention is as follows. It is comprised of an RF-IR converter and an RF remote-control device. The RF-IR converter comprises an IR transmitting circuit, an IR receiving circuit, a single chip processor and a memory, an RF signal receiving feedback module for communicating with the RF remote-control device is also fitted in the RF-IR converter. The RF remote-control device corresponds to the RF signal receiving feedback module. The embodiment can apply the technical solution of the present invention to RF-IR converting remote-control technology. Therefore, it can utilize RF signals to realize universal, omnidirectional remote control.

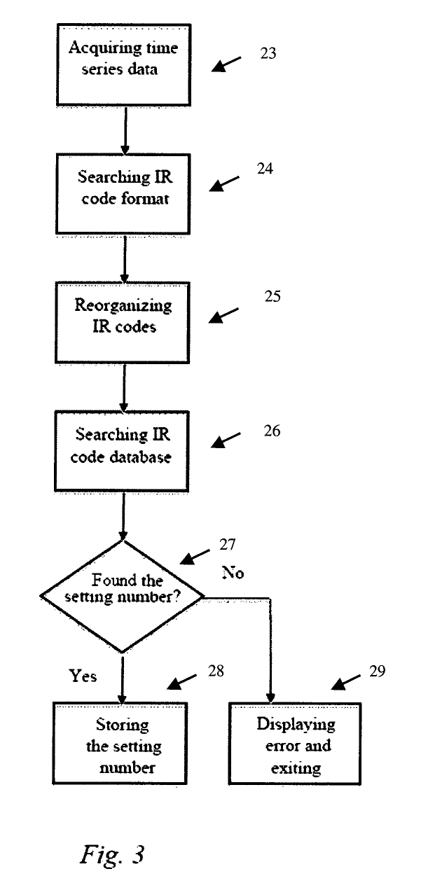

The setting method of the present invention is executed, as shown in FIG. 3, by the steps as follows:

1) receiving codes: making the original IR remote-control device correspond to the signal receiving port of the IR receiving circuit (18) of the universal remote-control device, and pressing a prescribed key for the IR receiving circuit to acquire IR signals corresponding to the prescribed key; The single chip processor (16) will execute the program to acquire the time series data (23) and store into its internal memory.

2) calculating: having the acquired IR signals corresponding to the prescribed key analyzed and solved, to search and calculate such information concerning the IR signals as digit number, head code time, 0/1 code time, times of frame, frequency of IR carrier wave, etc., so that the parameters of an IR format can be characterized. Based on such parameters, we can search for the IR code format (24) which is applicable to the acquired IR signal. After IR code format can be found, MCU can re-organize the acquired IR signal in to IR code (25) which can be recognized by the internal database.

3) comparing: comparing the above information codes with data in the database (26) to find matched data in the database (27), that is, to locate said data and obtain a setting number;

4) setting: storing the setting number (28), and forming in accordance with the setting number a selected setting function with one-to-one correspondence between the keys of the key operation circuit of the universal remote-control signal transmitting device and the keys of the original IR remote-control device; and

5) In case the appropriate setting number cannot be found, the program will either display error (29) or request user to use other setting method and then exit.

6) completing.

Although the present invention has been described in relation to particular embodiments thereof, many other variations and modifications and other uses will become apparent to those skilled in the art. It is preferred, therefore, that the present invention be limited not by the specific disclosure herein, but only by the appended.

What is claimed is:

1. A universal remote-control signal transmitting device for controlling IR (infrared) equipment, comprising:
an IR transmitting circuit configured for sending IR signals for controlling various pieces of controlled equipment to be controlled and a key control device, configured and operable to pair said universal remote-control signal transmitting device with a piece of said controlled equipment, so that after the pairing, the universal remote-control signal transmitting device can replace an original IR remote-control device of said one piece of controlled equipment;
the universal remote-control signal transmitting device also being fitted with an IR receiving circuit and with a memory for storing an IR signal code database and programs for analyzing and processing; the IR receiving circuit being configured to receive signals transmitted by said original IR remote-control device upon a selected operation of said key control device, a single chip processor and a memory configured to analyze and process the signals, and is configured to then obtain from the database of the memory one setting number corresponding to said signals, wherein, said setting number makes a one-to-one correspondence between the key in said key control device and the key in said original IR remote-control device; said IR transmitting circuit being configured to transmit, in accordance with the action of each key in said key control device, IR command signals which can instruct said one piece of controlled equipment to execute an operation.

2. Setting method performed by the universal remote-control signal transmitting device according to claim 1, comprising steps as follows:
(1) receiving codes: making the original IR remote-control device correspond to the signal receiving port of the IR receiving circuit of said universal remote-control device, and then pressing a prescribed key for the IR receiving circuit to acquire IR signals corresponding to said prescribed key;
(2) calculating: analyzing and solving the acquired IR signals corresponding to said prescribed key, searching and calculating such information of the IR signals including digit number, head code time, 0/1 code time, times of frame, and frequency of IR carrier wave, and organizing codes for the information;
(3) comparing: comparing the above information codes with data in a database to find matched data in the database, to locate said data and obtain a setting number; and
(4) setting: storing the setting number, and forming in accordance with said setting number a selected setting function with one-to-one correspondence between the keys of the key operation circuit of said universal remote-control signal transmitting device and the keys of said original IR remote-control device.

3. The setting method for the universal remote-control signal transmitting device according to claim 2, wherein when organizing the codes for the information of said IR signals in step 2), using an MCU to organize the information of said IR signals as information codes which can be recognized by the database.
